(19) United States
(12) Patent Application Publication
(10) Pub. No.: US 2011/0239471 A1
(43) Pub. Date: Oct. 6, 2011

(54) LEFT HANDED KNIVES SYSTEMS

(76) Inventor: Kathleen Day, New York, NY (US)

(21) Appl. No.: 13/075,242

(22) Filed: Mar. 30, 2011

Related U.S. Application Data
(60) Provisional application No. 61/318,859, filed on Mar. 30, 2010.

(51) Int. Cl. B25G 3/00; B26B 9/02

(52) U.S. Cl. 30/342

(57) ABSTRACT

The left-handed knives system comprises a collection of left-handed knives providing a set of cutlery tools for left-handed people. The left-handed cutlery set may generally comprise a plurality of individual left-handed knives which may be used for various purposes and tasks within the field of food preparation and dining. A left-handed knife may comprise a dishwasher-safe handle and stainless steel blade. The knife handle may be ergonomically designed to provide a left-handed contour profile thereby providing a comfortable and natural grip for a left-handed user. Further, the blade may comprise a sloped concave profile from left to right, thereby providing a balanced cutting action for the left-handed user during an in-use condition. Left-handed knives system may further comprise a carrying case for storing, displaying and/or transporting the left-handed cutlery set.

### CROSS-REFERENCE TO RELATED APPLICATION

The present application is related to and claims priority from prior provisional application Ser. No. 61/318,859, filed Mar. 30, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of cutlery tools and more specifically relates to a set of knives specifically adapted for use by a left-handed user.

2. Description of the Related Art

People of the Andes consider that left-handers possess special spiritual abilities, including magic and healing. Unfortunately, magic does little for left-handed individuals in a world predominantly populated by right-handers. Because the vast majority of the world's population is right-handed, most everyday items are mass-produced for ease of use with the right hand. Tools, game equipment, musical instruments and other items typically must be specially ordered for left-handed use, if they are even produced.

For example, knives are conventionally designed and orientated so that the cutting edge having serrations are on the left side of the blade. This may cause inconvenience and possibly dangerous cutting conditions for a left-handed user when using such knives, due to the improper angle at which a user may be forced cut. Further, a left-handed user may exert unnecessary force in overcoming the concave profile of a right-handed knife. This unnecessary physical exertion may cause wrist problems because of the inherently unnatural feel of a conventional knife to a left-handed user. Since knives are used in almost every kitchen during the preparation and processing of food, left-handed users often suffer in silence as they exert additional and unnecessary effort.

Further, the left-handed user may often be frustrated by the typical “overhanging” of food that the left-hander frequently experiences. A poorly cut loaf of bread, cake, or turkey may possibly detract from a perfectly good meal. An effective, safe-for-use left-handed cutlery set is needed to provide a left-handed individual with a personalized and complete set of left-handed designed cutting knives which may serve to reduce discomfort while cutting and preparing food.

Various attempts have been made to solve the above-mentioned problems such as those found in U.S. Pat. Nos. 2,958,943 to Koe et al; 4,885,818 to Arterbury; 5,572,793 to Collins et al; 6,502,314 to McCatty; D358,529 to Rich; and D287,042 to Hoffman. This prior art is representative of knives. None of the above inventions and patents, taken either singly or in combination, is seen to describe the invention as claimed.

Ideally, a left-handed knife should permit a left-handed user to comfortably cut food and other objects with the same amount of facility as a right-handed individual and, yet, would operate reliably and be manufactured at a modest expense. Further, the left-handed knife (set) should comprise an assortment of various types of blades for performing different cutting tasks. Thus, a need exists for left-handed knives system to provide a set of knives suitable and safe for use by left-handed users and to avoid the above-mentioned problems.

### BRIEF SUMMARY OF THE INVENTION

In view of the foregoing disadvantages inherent in the known left-handed knife art, the present invention provides a novel left-handed knives system. The general purpose of the present invention, which will be described subsequently in greater detail, is to provide a knife comprising a handle and a metal blade specially designed for left-handed individuals.

Left-handed knives system may comprise a cutlery set adapted for efficient and effective use by at least one left-handed user. The cutlery set may comprise an assortment of knives including, but not limited to a carving knife, a bread knife, a French knife, a boning knife, a steak knife, a dining knife, and an electric knife. Further, the left-handed cutlery set may further comprise left-handed sheers in certain embodiments (other knives may be present in other embodiments/sets.)

Each left-handed knife of the cutlery set may comprise a handle having an ergonomic shape which may be contoured to comfortably fit the left hand of a user. The left-handed knife may further comprise a metal blade comprising a blade anchor for mounting the metal blade to the handle. Further, the metal blade may comprise a serrated edge, wherein the edge may slope downward from left to right terminating in a sharp edge for effectively cutting. In such a manner, a left-handed user may comfortably cut food and other objects with greater ease and facility as compared to using a knife that is designed for a right-handed user.

Left handed knives systems may further comprise a carrying case for storing and transporting the left-handed cutlery set. The carrying case may provide an effective and convenient solution for left handed persons who wish to carry a cutting and dining knives set. This may be used for dining or for food preparation at other locations. Further, the carrying case may be utilized as a convenient storage location within a family house if a left-handed family member represents a minority.

The present invention holds significant improvements and serves as a left-handed knives system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, left-handed knives systems, constructed and operative according to the teachings of the present invention.

FIG. 1 is a perspective view illustrating a knife of a left-handed knives system in an in-use condition according to an embodiment of the present invention.

FIG. 2 is a perspective view illustrating a left-handed knife comprising a serrated edge according to an embodiment of the present invention of FIG. 1.

FIG. 3 is a perspective view illustrating the left-handed knife comprising a handle and a metal blade according to an embodiment of the present invention of FIG. 1.

FIG. 4 is a perspective view illustrating a carrying case for storing a left-handed cutlery set according to a preferred embodiment of the left-handed knives systems.

The various embodiments of the present invention will hereinafter be described in conjunction with the appended drawings, wherein like designations denote like elements.

### DETAILED DESCRIPTION

As discussed above, embodiments of the present invention relate to left-handed knives systems and more particularly to a set of cutlery tools as used to improve the ability for left-handed users to safely cut food and other objects with efficiency. For decades, left-handed users have been relegated to using tools designed for right-handed individuals. Virtually all restaurants and other public facilities provide utensils, sporting equipment, and other tools for right-handed users, but not for the perennially plagued “lefties” of the world. Consequently, left handed humans must often sacrifice comfort, safety and ease of use in order to accommodate the various tool or utensil designed and contoured for a right hand. This may often result in poorer performance, diminished eloquence, and at times a total inability to utilize that tool or utensil for a specific purpose.

In the field of cutlery, and more specifically in the field of food preparation and dining, knives may be used for slicing, which may be characterized by drawing the blade across the object and applying light pressure, and chopping, which may be characterized by pushing the blade through with some piercing. Unfortunately for left-handed individuals, the vast majority of knives, sheers, and other sharp food preparation tools are designed for right-handed users, as previously mentioned. The ability of a knife to cut arises from the concentration of the force applied to the blade onto a very small area, resulting in a high pressure on the matter to be penetrated. When a left handed person uses a knife that is designed for use by the right hand, the left handed individual may experience discomfort in holding the knife. Further, the blade which typically extends from the right side of the blade down to the left side is slanted in a counter-cutting productive incline for the left-handed user. Consequently, the left-handed user may have difficulties in performing even slices. Therefore, a primary object of the present invention is to provide a set of cutlery tools specifically designed and optimized for use by a left-handed user.

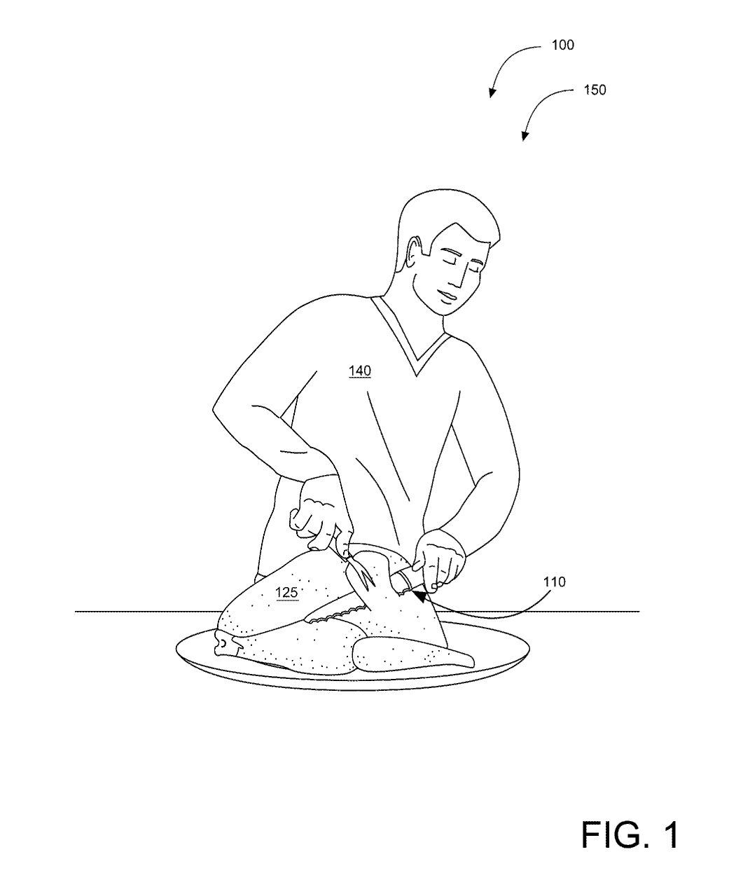

Referring to the drawings by numerals of reference there is shown in FIG. 1, left-handed knives systems 100 in an in-use condition 150 according to a preferred embodiment of the present invention. Left-handed knives systems 100 may generally comprise at least one left-handed knife 110 for cutting food or other objects. As seen, left-handed user 140 may cut turkey 125 utilizing left-handed knife 110 wherein left-handed knife 110 comprises a carving knife. It should be appreciated that left-handed knife 110 may comprise a plurality of different style knifes for performing various cutting and slicing tasks. It should also be appreciated that left-handed knife 110 may be used in other applications such as butchering, carpentry, baking and the like. Left-handed knife 110 may also comprise a dining utensil in certain embodiments discussed subsequently herein.

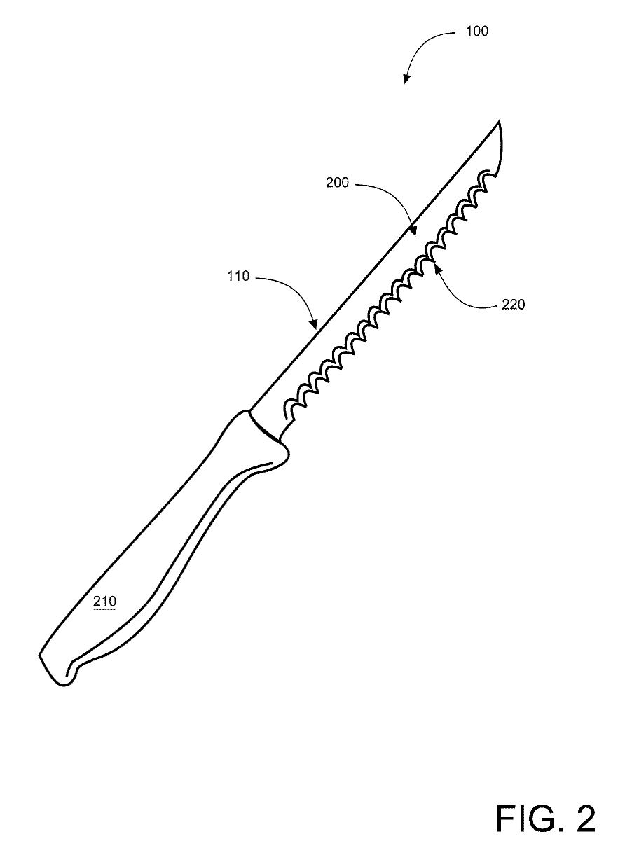

In now referring to FIG. 2, showing a perspective view of left-handed knife 110 generally comprising blade 200 and knife handle 210. In a preferred embodiment of left-handed knives systems 100, blade 200 may integrally comprise stainless steel. In alternative embodiments, blade 200 may comprise flacking stone. In a preferred embodiment, blade 200 comprises a material that is dishwasher-safe to improve ease of continued use. It should be appreciated that many forms of materials may be used.

As shown in FIG. 2, blade 200 may comprise serrated edge 220. Serrated edge 220 may generally comprise a plurality of sharp teeth. It should be appreciated that in alternative embodiments of blade 200, the teeth may vary in sharpness, thickness, and quantity depending on the design of left-handed knife 110.

In continuing to refer to FIG. 2, knife handle 210 may comprise a left-handed contour profile facilitating the ease of use by left-handed user 140. When in an in-use condition 150, left-handed user 140 may comfortably grip knife handle 210 thereby enabling left-handed user 140 to effectively use left-handed knife 110. In a preferred embodiment of left-handed knives systems 100, knife handle 210 may comprise a durable and dishwasher safe plastic material. In alternative embodiments, knife handle 210 may comprise wood, rubber, leather, or stainless steel. It should be appreciated that knife handle 210 may be manufactured utilizing a variety of colors and materials based upon consumer preference. In certain embodiments indicia may be inscribed on knife handle 210 or blade 200 designating left-handed knife 110 and the name of the product, manufacturer or the like. Serrated edge 220, within the particular embodiment shown augments a natural anti-clockwise twisting motion during an in-use condition 150 (as shown in FIG. 1) thereby providing a balanced cutting action for left-handed user 140 because the angling of blade 200 facilitates safe and proper angled carving/cutting by left-handed user 140 when cutting in a direction from left to right. Serrated edge 220 comprises a concave profile sloping from left to right to provide this unique feature. The sharp edge for cutting comprises a leading edge, and is followed by a trailing edge for ‘sluffing’ the meat off, as carved.

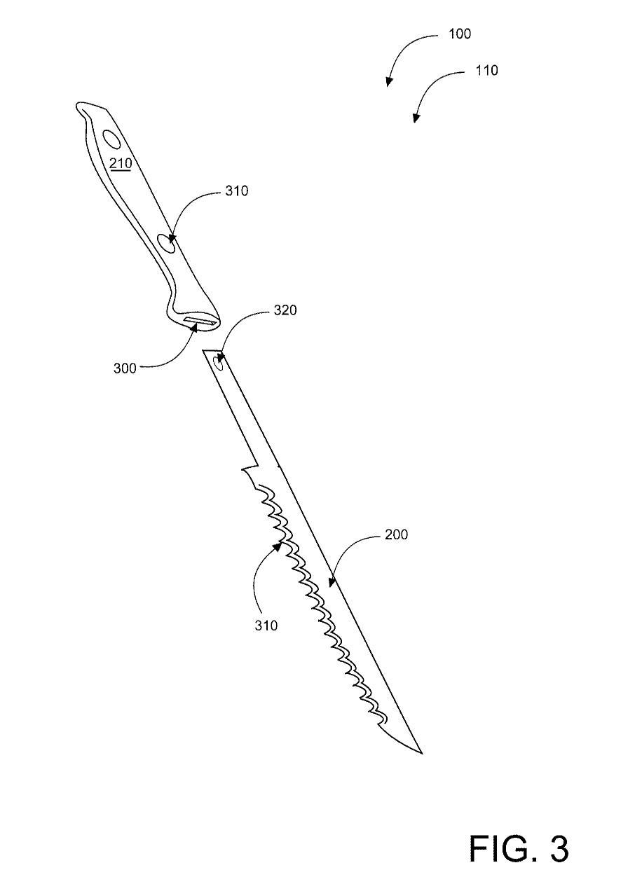

Referring now to FIG. 3, illustrating the individualized components of left-handed knives systems 100 according to embodiments of the present invention of FIGS. 1-2. As shown, knife handle 210 may comprises a left-handed contoured design, providing shallow finger indentures for the left hand and further comprising a dipped recess for providing natural and comfortable support for the palm of the left hand during an in-use condition 150. Further, knife handle 210 may comprise handle grip 310 located on an outer top surface of handle 210. Handle grip 310 may comprise rubber or plastic and may serve to provide a gripped surface for knife handle 210. Handle grip 310 is conveniently located so that left-handed user 140 may comfortably hold and use left-handed knife 110.

In continuing to refer to FIG. 3, knife handle 210 may further comprise blade insert 300 for receiving blade 200. To install left-handed knife 110, blade 200 is insertable into knife handle 210 via blade insert 300 where it may be securably mounted via conventional attachment manufacturing methods. Such methods may comprise utilizing a full tang, a partial tang, or a through-tang. Blade 200 may further comprise blade anchor 320 for further mounting blade 200 to knife handle 210.

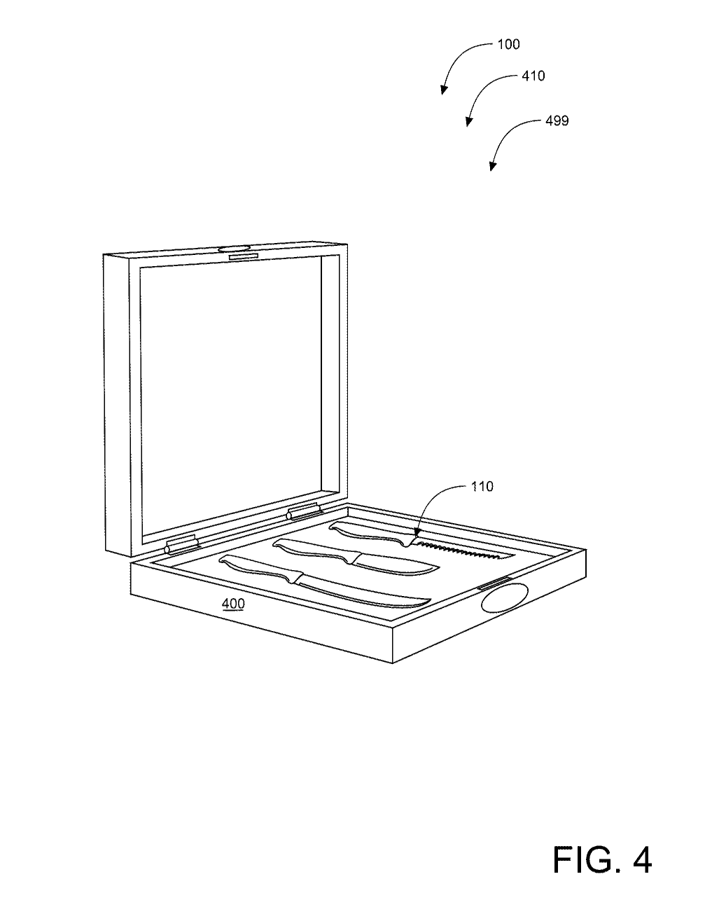

Referring now to FIG. 4, showing left-handed knives systems 100 comprising left-handed cutlery set 410. Left-handed knives systems 100 may be sold as kit 499 comprising the following parts: at least one carrying case 400 at least one left-handed cutlery set 410; and at least one set of user instructions. Further, kit 499 may further comprise a pair of left-handed kitchen sheers (not shown) as well as at least one left-handed knife sharpener (not shown). Left-handed knives systems 100 may be manufactured and provided for sale in a wide variety of sizes and shapes for a wide assortment of applications. It should further be appreciated that left-handed cutlery set 410 may be customized to comprise a plurality of left-handed knives 110 wherein left-handed knife may comprise a bread knife, a French knife, a carving knife, a boning knife, a steak knife, an electric knife, and dining knives. Other knives, cutlery, maintenance and cleaning tools may be also included.

In an alternative embodiment of left-handed knives systems 100, left handed knife 110 may comprise an electric knife. The left-handed knife 110 comprising an electric knife may comprise two metal blades 200 that may be slidably connected in a parallel relation to each other. Preferably, each blade 200 comprises serrated edge 220. When in an in-use condition 150, blades 200 may continuously move back and forth, adjacent to each other to provide a cooperative sawing action. In such a manner, food may be cut faster and easier as compared to cutting manually means.

In referring to the varying embodiments of left-handed knives systems 100, left-handed knife 110 may comprise indicia on a surface of blade 200, as discussed above. Indicia may take the form of inscribed words, emblems, or other depictions. In one embodiment of the present invention, blade 200 may comprise the phrase “Left Handed Cutlery Collection” in a cursive inscription. Blade 200 may further comprise the signature of the manufacturer.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A left-handed knife for cutting comprising:
a metal blade comprising a right side and a left side;
a knife handle that is left-handed contoured;
at least one blade anchor;
wherein said right side of said metal blade comprises a sharp edge for cutting;
wherein said left side of said metal blade comprises a dull edge;
wherein said metal blade is securably mounted to said knife handle via said at least one blade anchor; and
wherein said left-handed knife provides an optimized cutting tool for use by a left-handed user via providing a proper cutting inclination for said left-handed user.

2. The left-handed knife of claim 1, wherein said right side of said metal blade comprises a serrated edge.

3. The left-handed knife of claim 2, wherein said serrated edge comprises a concave profile sloping from left to right.

4. The left-handed knife of claim 3, wherein said serrated edge augments a natural anti-clockwise twisting motion during an in-use condition thereby providing a balanced cutting action for said left-handed user.

5. The left-handed knife of claim 1, wherein said sharp edge for cutting comprises a leading edge.

6. The left-handed knife of claim 1, wherein said dull edge for cutting comprises a trailing edge.

7. The left-handed knife of claim 1, wherein said left-handed knife comprises a boning knife.

8. The left-handed knife of claim 1, wherein said left-handed knife comprises a bread knife.

9. The left-handed knife of claim 1, wherein said left-handed knife comprises a carving knife for carving large cooked meats.

10. The left-handed knife of claim 1, wherein said left-handed knife comprises a French knife.

11. The left-handed knife of claim 1, wherein said left-handed knife comprises a dining utensil.

12. The left-handed knife of claim 1, wherein said left-handed knife is electrically operated.

13. The left-handed knife of claim 12 further comprising two of said metal blades comprising serrated edges.

14. The left-handed knife of claim 13, wherein said two metal blades are slidably connected in a parallel relation.

15. The left-handed knife of claim 14, wherein said two metal blades continuously move back and forth adjacently when electrically operated to provide a cooperative sawing action.

16. The left-handed knife of claim 1, wherein said metal blade comprises a dishwasher-safe ferrous material.

17. A left-handed cutlery set for a left-handed user comprising:
at least one left-handed knife comprising a metal blade comprising a right side, wherein said right side comprises a dull, trailing edge, and a left side, wherein said left side comprises sharp, leading edge, said sharp, leading edge further comprising a plurality of serrated teeth;
at least one knife handle that is left-handed contoured;
at least one blade anchor;
wherein said at least one metal blade is securably mounted to said at least one knife handle via said at least one blade anchor; and
wherein said left-handed knife provides an optimized cutting tool for use by a left-handed user via providing a proper cutting inclination for said left-handed user.

18. The left-handed cutlery set of claim 17, wherein said metal blade of said left-handed knife comprises different sizes, shapes and degrees of sharpness, thereby forming said left-handed cutlery set.

19. A left-handed knives system comprising a kit, wherein said kit comprises:
a left-handed cutlery set;
a carrying case;
wherein said left-handed cutlery set comprises at least one boning knife, at least one bread knife, at least one carving knife, at least one French knife,at least one dining knife, at least one steak knife, at least one electric knife, and at least one set of user instructions; and
wherein said set of left-handed knives is storable within said carrying case.

20. The left-handed knives system of claim 19 wherein said kit further comprises left-handed kitchen sheers.
